(19) United States
(12) Patent Application Publication
(10) Pub. No.: US 2025/0226950 A1
(43) Pub. Date: Jul. 10, 2025

(54) LOW-POWER REFERENCE SIGNAL FOR CHANNEL MEASUREMENT

(71) Applicant: Sony Group Corporation, Tokyo (JP)

(72) Inventors: Nafiseh MAZLOUM, Lund (SE); Anders BERGGREN, Lund (SE); Torgny PALENIUS, Barsebäck (SE); Basuki PRIYANTO, Lund (SE)

(21) Appl. No.: 18/843,634

(22) PCT Filed: Mar. 17, 2023
(86) PCT No.: PCT/EP2023/056944

§ 371 Date: Sep. 3, 2024

(30) Foreign Application Priority Data
Mar. 18, 2022 (SE) 2250341-1

(51) Int. Cl. H04L 5/00; H04W 8/22; H04W 52/02; H04W 76/28

(52) U.S. Cl. CPC H04L 5/0051; H04W 8/22; H04W 52/0235; H04W 76/28

(57) ABSTRACT

A low-power reference signal is broadcasted by a base station. The low-power reference signal is designed for reception by a low-power receiver. Wireless communication devices can perform channel measurements using the low-power reference signal without having to activate a main receiver, e.g., to receive a synchronization signal block.

### TECHNICAL FIELD

Various examples of the disclose pertain to a reference signal designed for reception by a low-power receiver of a wireless communication device. Various examples of the disclosure pertain to control signaling pertaining to activation of a respective periodic broadcasting pattern of the reference signal.

### BACKGROUND

Energy-efficient operation is a key design requirement for wireless communication devices (user equipment; UE). A low power consumption facilitates prolonged battery life. Furthermore, smaller batteries, e.g., coin-cell batteries can be used. Internet of Things smart devices can be enabled.

One technique to facilitate low power consumption is to employ multiple receivers, a main receiver and a low-power receiver. For instance, the low-power receiver may be configured for non-coherent decoding. For non-coherent decoding, knowledge of a reference phase is not required for signal detection. This can significantly reduce the energy consumption required for channel listening.

See, e.g., WO 2020/074454 A1 or EP 3 704 899 B1.

### SUMMARY

A need exists for energy-efficient operation of UEs.

This need is met by the features of the independent claims. The features of the dependent claims define embodiments.

Techniques for operating a UE at low power consumption are disclosed. The techniques employ a low-power reference signal (LP-RS), to support measurement and assessment of serving cell signal strength for UEs using a low-power receiver (LP-Rx).

A method of operating a base station is disclosed. The base station is associated with a cell of a cellular network. The method includes activating a first periodic broadcasting pattern of a reference signal. The reference signal is mapped to subcarriers of a carrier. The carrier supported by the base station. The method also includes, while the first periodic broadcasting pattern is activated: activating a second periodic broadcasting pattern of a low-power reference signal. The low-power reference signal is designed for a non-coherent decoding at wireless communication devices that are located in the cell. The first periodic broadcasting pattern has a predetermined relationship with respect to the second periodic broadcasting pattern. The method also includes providing at least one control signal to the wireless communication devices. The at least one control signal is indicative of activation of the second periodic broadcasting pattern.

A base station executing such method is disclosed.

A computer program or a computer-program product or a computer-readable storage medium includes program code that can be loaded and executed by at least one processor. The at least one processor, upon executing the program code, performs a method of operating a base station. The base station is associated with a cell of a cellular network. The method includes activating a first periodic broadcasting pattern of a reference signal. The reference signal is mapped to subcarriers of a carrier. The carrier supported by the base station. The method also includes, while the first periodic broadcasting pattern is activated: activating a second periodic broadcasting pattern of a low-power reference signal. The low-power reference signal is designed for a non-coherent decoding at wireless communication devices that are located in the cell. The first periodic broadcasting pattern has a predetermined relationship with respect to the second periodic broadcasting pattern. The method also includes providing at least one control signal to the wireless communication devices. The at least one control signal is indicative of activation of the second periodic broadcasting pattern.

A method of operating a wireless communication device is disclosed. The method includes obtaining a control signal from a base station associated with a cell of a cellular network. The control signal is indicative of activation of a second periodic broadcasting pattern of a low-power reference signal. The low-power reference signal is designed for a non-coherent decoding at wireless communication devices that are located in the cell. The method also includes, upon camping on the cell of the cellular network in an idle mode using discontinuous reception: selecting, for channel measurements at the wireless communication device, between monitoring of a reference signal that is broadcasted using a first periodic broadcasting signal and monitoring of the low-power reference signal that is broadcasted using the second periodic broadcasting pattern. The first periodic broadcasting pattern has a predetermined relationship with respect to the second periodic broadcasting pattern.

A wireless communication device executing such method is disclosed.

A computer program or a computer-program product or a computer-readable storage medium includes program code that can be loaded and executed by at least one processor. The at least one processor, upon executing the program code, performs a method of operating a wireless communication device. The base station is associated with a cell of a cellular network. The method includes obtaining a control signal from a base station associated with a cell of a cellular network. The control signal is indicative of activation of a second periodic broadcasting pattern of a low-power reference signal. The low-power reference signal is designed for a non-coherent decoding at wireless communication devices that are located in the cell. The method also includes, upon camping on the cell of the cellular network in an idle mode using discontinuous reception: selecting, for channel measurements at the wireless communication device, between monitoring of a reference signal that is broadcasted using a first periodic broadcasting signal and monitoring of the low-power reference signal that is broadcasted using the second periodic broadcasting pattern. The first periodic broadcasting pattern has a predetermined relationship with respect to the second periodic broadcasting pattern.

It is to be understood that the features mentioned above and those yet to be explained below may be used not only in the respective combinations indicated, but also in other combinations or in isolation without departing from the scope of the invention.

### BRIEF DESCRIPTION OF THE DRAWINGS

FIG. 1 is a schematic illustration of a communication system according to various examples.

FIG. 2 schematically illustrates a base station according to various examples.

FIG. 3 schematically illustrates a UE according to various examples.

FIG. 4 is a flowchart of a method according to various examples.

FIG. 5 is a flowchart of a method according to various examples.

FIG. 6 schematically illustrates multiple periodic broadcasting patterns according to various examples.

FIG. 7 schematically illustrates a low-power reference signal according to various examples.

FIG. 8 is a signaling diagram according to various examples.

FIG. 9 is a flowchart of a method according to various examples.

FIG. 10 schematically illustrates a received signal strength of a low-power reference signal according to various examples.

### DETAILED DESCRIPTION

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Hereinafter, techniques of wirelessly transmitting and/or receiving (communicating) between multiple communication nodes are described. In the various examples described herein, various types of communication systems may be used. For example, a communication network may be employed. The communication network may be a wireless network. For sake of simplicity, various scenarios are described hereinafter with respect to an implementation of the communication network by a cellular network. The cellular network includes multiple cells. Each cell corresponds to a respective sub-area of the overall coverage area. Other example implementations include a multi-area wireless network such as a cellular WiFi network, etc.

Hereinafter, techniques are explained with respect to a UE communicating with a base station (BS) of a cellular NW.

Energy efficiency is a key design requirement for UEs with limited energy resource, e.g., UEs using small rechargeable coin cell batteries. Among use cases, sensors and actuators are deployed extensively for monitoring, measuring, charging, etc. Generally, their batteries are not rechargeable and expected to last up to or at least few years as described in 3GPP Technical Requirement (TR) 38.875 v17.0.0. Wearables include smart watches, rings, eHealth related devices, and medical monitoring devices. With typical battery capacity, it is challenging to sustain up to 1-2 weeks.

Various techniques disclosed herein facilitate low power consumption for such and other types of UEs.

According to various examples, a UE includes a M-Rxmain receiver (M-Rx) and a low-power receiver (LP-Rx).

The low-power receiver may be configured to perform time-domain processing to detect certain signals, e.g., a wake-up signal (WUS). The time-domain processing can be in the baseband. The low-power receiver may be unfit to perform Orthogonal Frequency Division Multiplex, OFDM demodulation, i.e., of decoding symbols on multiple orthogonal subcarriers of a joint carrier. For example, the low-power receiver may be configured to perform non-coherent decoding. For non-coherent decoding, knowledge of a reference phase is not required for signal detection.

The M-Rx may be configured for OFDM demodulation.

The LP-Rx may facilitate WUS techniques. The WUS techniques enable a UE to transition a M-Rx into a low-power state, e.g., for power-saving purposes. In some examples, the low-power state of the M-Rx may be an inactive state. The inactive state can be characterized by a significantly reduced power consumption if compared to an active state of the MRx. For example, the M-Rx may be unfit to receive any data in the inactive state such that some or all components may be shut down. Wakeup of the M-Rx from the inactive state (i.e., transitioning into an active state) is then triggered by a WUS. The inactive state can be associated with various operational modes of the terminal, e.g., a disconnected mode or idle mode. Here, a data connection between the terminal and the cellular network can be released.

The WUS can be detected by the LP-Rx.

As a general rule, the LP-Rx and M-Rx may be implemented within the same hardware component(s) or may be implemented by at least one different hardware component.

A use of an extra LP-Rx, in addition to the M-Rx, where the LP-Rx listens for potential DL channel/signal, can reduce the cost of idle channel listening significantly and therefore reduce the UE power consumption.

Various techniques are based on the finding that in cellular-based communication systems the UEs needs to perform some certain measurement prior performing communication to make sure the signal strength of the serving cell is at adequate level (channel measurement). According to existing implementations, the signal used for channel measurements, i.e., respective reference signals, can only be measured by the M-Rx. When the UE is configured with discontinuous reception (DRX) operation (idle mode DRX), it typically needs to perform the measurement on the serving cell every DRX cycle to make sure of the signal strength. The required measurement rate of the serving cell is specified in 3GPP TS 38.133, section 4.2.2.2. This means that the UE, even if it is equipped with an LP-Rx, needs to transition the M-Rx into the active state and perform the channel measurement. This can cause a sub-optimal power consumption.

Hereinafter, techniques are disclosed that support channel measurements, e.g., to monitor the serving cell, for UEs with LP-Rx. In principle, the UE only needs to activate and use M-Rx when there is a need to communicate with the serving cell, e.g., uplink (UL) data transmission, downlink (DL) data reception, e.g., as indicated by a WUS (the WUS can be received by the LP-Rx). The channel measurement can be performed by the LP-Rx, using a low-power reference signal (LP-RS).

The LP-RS can be transmitted using the same transmit power as other, neighboring signals, but is directed towards a LP-Rx.

According to various examples, a first periodic broadcasting pattern of a reference signal is activated. I.e., a transmission of the reference signal in accordance with a certain timing and frequency scheme is activated. The reference signal is mapped to orthogonal subcarriers of a carrier that is supported by the BS. While the first periodic broadcasting pattern is activated, additionally, a second periodic broadcasting pattern of a LP-RS is activated. The LP-RS is designed for a non-coherent decoding at UEs located in the cell of the BS. The first periodic broadcasting pattern has a predetermined relationship with the second periodic broadcasting pattern. Also, at least one control signal is provided to the UEs, wherein the at least one control signal is indicative of activation of the second periodic broadcasting pattern.

Accordingly, the first periodic broadcasting pattern can correspond to the legacy transmission of the synchronization signal (SS) block (SSB). The SSB includes a primary SS (PSS) and a secondary SS (SSS). The SSB is described in 3GPP TS 38.211 v17.0.0. The first periodic broadcasting pattern may thus be termed SSB broadcasting pattern.

The second periodic broadcasting pattern can thus correspond to the transmission of the LP-RS and may thus be termed LP-RS broadcasting pattern.

The broadcasting patterns can generally specify a time and/or frequency of transmissions of the respective reference signal. The broadcasting patterns can specify certain time-frequency resources, e.g., defined with respect to subframes of a frame pattern, allocated to the respective reference signal.

The LP-RS broadcasting pattern can specify a timing schedule of transmission of the LP-RS. Alternatively or additionally, the LP-RS broadcasting pattern can specify a frequency or frequency range, e.g., a bandwidth part, within which the LP-RS is transmitted. The broadcasting pattern can specify time-frequency resources of an OFDM resource grid allocated to the transmission of the LP-RS.

The predetermined relationship can correspond to a fixed relative arrangement of transmissions of the LP-RS and the SSB in time and/or frequency. The predetermined relationship can correspond to a certain offset, e.g., in time domain and/or frequency domain, of time-frequency resources allocated to the transmission of the LP-RS and the SSB, respectively.

By having activated, with the certain predetermined relationship with respect to each other, both, the SSB broadcasting pattern, as well as the LP-RS broadcasting pattern, the UEs in the cell may flexibly select between implementing channel measurements either based on the SSB and/or based on the LP-RS. This facilitates low-power operation of the UEs. For instance, the M-Rx may only transition to the active state where there is a need to communicate data, e.g., uplink (UL) data or DL data.

In detail, a UE can receive, from the BS, the control signal that is indicative of the activation of the LP-RS broadcasting pattern. Then, upon camping on the cell of the BS in an idle mode using DRX, the UE may select between monitoring of the SSB broadcasted using the SSB broadcasting pattern and monitoring of the LP-RS that is broadcasted using the LP-RS broadcasting pattern.

Aspects with respect to a sequence design of the LP-RS will be disclosed. Conditions and aspects of performing a channel measurement when such LP-RS is available are disclosed. Aspects related to configuration of a periodic broadcast transmission of the LP-RS are disclosed.

A BS can activate a LP-RS broadcasting pattern of the LP-RS. The LP-RS is decoded by a LP-Rx. The LP-RS may be designed for non-coherent demodulation at UEs in the cell of the BS. The LP-Rx may be a non-coherent receiver.

The LP-RS can be designed to have the same characteristics as a WUS, i.e., can have a lower complexity than the existing reference and synchronization signals. See, e.g., 3GPP TS 36.211 Version 17.0.0, e.g., section 6.11B or section 10.2.6B.

A typical LP-Rx has a simple modulation and coding technique. It can be a pseudonoise (PN) code sequence modulated by On-Off keying modulation and for instance Manchester coding or spreading and can be decoded by a simple receiver consisting of an envelope detector and a correlator. Both, LP-RS and WUS may be designed with the above design characteristics.

Next, the time and frequency allocation of the LP-RS periodic broadcasting pattern is discussed. The LP-RS may be accommodated in certain frequency resources with a bandwidth in the range of 2 to 5 MHz which is smaller than the maximum bandwidth of a legacy RedCap UE or a legacy eMBB UE. I.e., only a fraction of the receiver bandwidth supported by the M-Rx may be used by the LP-RS.

The LP-RS may be allocated within the same bandwidth part (BWP) as the WUS. The BWP for transmission of the LP-RS and WUS can be a part of initial BWP or can be a BWP dedicated for LP-RS and WUS transmission. Thus, for example responsive to a wake-up event associated with a given UE, the BS may transmit to that UE a wake-up signal that is also designed for the noncoherent decoding, wherein the wake-up signal and the LP-RSs are transmitted in a joint bandwidth part.

The LP-RS may be transmitted on a different bandwidth part as the synchronization signal block (SSB); this could be captured by the respective predetermined relationship between the LP-RS broadcasting pattern and the SSB broadcasting pattern. LP-RS may be transmitted in a bandwidth part with a specific numerology and it may be different numerology than the bandwidth part for SSB. It would also be possible that the SSB and the LP-RSs are transmitted at the same frequency, e.g., in the same bandwidth part, or in the same center frequency.

A BWP is generally defined by a frequency range that is a subset of the entire bandwidth of a carrier. A BWP can be implemented by a contiguous set of time-frequency resources that are selected from a contiguous subset of the common time-frequency resources for a given numerology on a given carrier. BWPs are described in 3GPP Technical Specification (TS) 38.211, Version 16.4.0, 2021 Jan. 8. I.e., different BWPs share the same carrier. In reference implementations, only a single BWP can be active at a time (active BWP) for a UE. Various techniques are available for switching between BWPs. A specific BWP can be activated by Bandwidth part indicator in DCI Format 0_1 (a UL Grant) and DCI Format 0_1 (a DL Schedule). An inactivity timer can be used. RRC signaling can be used.

The LP-RS periodicity is configurable and can be configured to have the same periodicity as the SSB periodicity. The LP-RS periodicity could also be an integer multiple of the SSB periodicity. The LP-RS periodicity could also be a fraction of the SSB periodicity. The transmission timings of the LP-RS and the SSB may be offset with respect to each other, by a certain time distance ta. The time distance ta may be dimensioned long enough to be able to accommodate WUS and a transition time for a main radio to wake-up. With this configuration both latency for waking up a device and UE power consumption are reduced.

The periodicity of transmission of the LP-RS limits the maximum measurement rate for monitoring for the LP-RS.

The LP-RS can be based on a sequence generator.

In an SSB, both the primary SS (PSS) and the secondary SS (SSS) are m-sequences and thus they do have the signal characteristics as described above. To accommodate more information, low complexity coding or spreading code can be added on top of the generated signals.

For simplicity and to avoid extra configuration and design effort, the LP-RS can carry the same information bits as carried by PSS and SSS in an SSB. The LP-RS can be cell specific, e.g., encode a cell identity. The advantage of including the same information as PSS and SSS in the LP-RS is that as soon as the UE camps on the serving cell it also knows what is carried in the LP-RS and no extra configuration or information exchange is required. An alternative is to use a different sequence than SSS and/or PSS. For this, the BS needs to inform the UE about the new sequence either by Radio Resource Control (RRC) signaling or the system information block (SIB) as a part of configuration information.

The BS transmits the LP-RS in certain allocated frequency and time resources so that the LP-RS is detectable by a LP-Rx without creating any interference with other OFDM transmissions. For this, the transmitter can apply techniques as disclosed in WO 2020/074454 A1 to embed the LP-RS to ensure both orthogonality to other OFDM transmission and reception by a non-coherent ultra-low power receiver. LP-RS can be accommodated to more than one OFDM symbol if necessary.

A UE equipped with the LP-Rx may choose to attempt to receive (monitors for) the LP-RS upon receiving a receptive control signal that is indicative of the activation of the LP-RS broadcasting pattern; and, upon detecting the LP-RS, can evaluate whether the signal strength of the serving cell is sufficient or not. For example, the UE can only evaluate the signal strength of LP-SSS part of the LP-RS.

Since the UE already knows its serving cell, the UE is aware of the activated/activation of a LP-RS periodic broadcasting pattern. Therefore, it only needs to perform measurements on the serving cell by evaluating the signal strength of the LP-RS. This is similar to what is included in legacy for Radio Resource Management (RRM) measurement but here the UE only needs to use its LP-Rx to evaluate the signal strength of the serving cell. The signal strength evaluation can be based on the reference signal received power (RSRP) of the LP-RS which is defined as the linear average over the power contributions (in [W]) of the respective signal. The signal strength evaluation can be based on the RSRP of the LP-SS of the LP-RS.

For instance, a decision criterion in selecting between monitoring for the SSB and monitoring for the LP-RS could be the signal strength of the LP-RS as previously received. An example implementation is explained in further detail below.

If the signal strength of the LP-RS of the serving cell is sufficient, i.e., γ>l₁, the UE may continue performing camping on that cell.

If the signal strength is below a certain level (l₁), i.e., γ<l₁, but the signal strength does not change, the UE can continue to measure on LP-RS until the signal strength starts to change, e.g., due to mobility or a blockage. The selection between monitoring for LP-RS and SSB thus can depend on the mobility level of the UE. For example, under such conditions, the UE start the procedure described below.

If the signal strength is below a certain level (l₁), i.e., γ<l1, and the signal strength changes over time (large change rate of the signal strength of the LP-RS signal strength), then the UE may prepare for potential re-selection of serving cell. For this, a UE can follow legacy operation, i.e., transitions the M-Rx to the active state and use SSB for neighbor cell measurement.

If the signal strength level is on border limit of threshold l₁ and changes very often over a short period, then the UE can still continue to performing measurement and operating using its LP-Rx. In other words, a temporal hysteresis of switching between monitoring the LP-RS and monitoring the SSB can be taken into account when selecting between monitoring the SSB and monitoring the LP-RS.

Such selection criteria for selecting between monitoring of the LP-RS or monitoring of the SSB as discussed above can be combined in various forms, not only in the specific scenarios disclosed above.

For instance, if the LP-RS is too weak, the M-Rx can be transitioned to the active state. Then based on a channel measurement performed on SSB by the M-Rx, a decision may be made to stay on the current cell. For instance, the M-Rx may stay activated until the signal strength increases above a threshold. Furthermore, if M-Rx measurement is further improved, such as X dB above the legacy M-Rx based measurement threshold for the serving cell, the UE can operate the LP-Rx based measurement and deactivate M-Rx, so that the power consumption can be reduced.

Next, aspects with respect to the measurement periodicity are disclosed:

The UEs, in idle mode, typically need to perform channel measurement every DRX cycle. UEs with low-mobility or stationary UE do not need to perform the measurement on every DRX cycle and the rate or specifically periodicity of performing channel measurement on LP-RS of the serving cell can be done following the measurement rule in 3GPP TS 38.133, section 4.2.2.9.

Thus, as a general rule, upon selecting said monitoring of the SSB, the channel measurement can be performed based on the SSB at a first rate; while, upon selecting said monitoring of the LP-RS, the channel measurements can be performed at a second rate; the first rate can be larger than the second rate (i.e., LP-RS may be monitored less frequently).

As a general, the first rate and the second rate can respectively be limited by respective rates at which the respective signals are transmitted (i.e., cannot be higher than the repetition rate of the respective reference signals).

In addition, the UE can have a fallback measurement. This can be trigger-based or be implemented periodically, for instance with a periodicity with the M-Rx ten times lower than the periodicity of performing measurement on LP-RS. This is typically the case when the LP-RS measurement is slightly higher than the threshold. The M-Rx measurement is used to validate the UE can keep to perform measurement with LP-Rx or completely fallback to perform measurement using M-Rx. Completely fallback means the UE performs measurement with M-Rx more often than the measurement with LP-Rx.

For instance, the second rate with which the LP-RS is monitored can be dependent on one or more criteria, e.g., a signal strength of the LP-RS. If the signal strength of the LP-RS is above a certain predefined threshold, the second rate may be reduced.

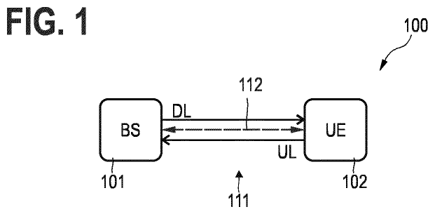

FIG. 1 schematically illustrates a communication system 100. The communication system includes two nodes 101, 102 that are configured to communicate with each other via a data carrier 111. In the example of FIG. 1, the node 101 is implemented by an access node, more specifically a BS, and the node 102 is implemented by a UE. The BS 101 can be part of a cellular NW (not shown in FIG. 1).

As illustrated in FIG. 1, there can be DL communication, as well as UL communication.

The UE 102 and the BS 101 can communicate on the data carrier 111. The data carrier 111 may include multiple subcarriers for OFDM modulation. A data link 112 can be implemented on the data carrier 111. The data link 112 can include one or more logical channels that define a time-frequency resource grid. The data link 112 can be established, e.g., based on a random-access procedure of the UE 102, e.g., responsive to paging and a wakeup event that may trigger transmission of a WUS to the UE 102. The data link 112 can be established when operating in the connected mode; but may not be established when operating in the idle mode.

Multiple BWPs may be defined on the carrier 111. A single scheduler at the BS 101 may allocate time-frequency resources to various signals on the carrier 111. Different control messages for scheduling may be used for the different BWPs.

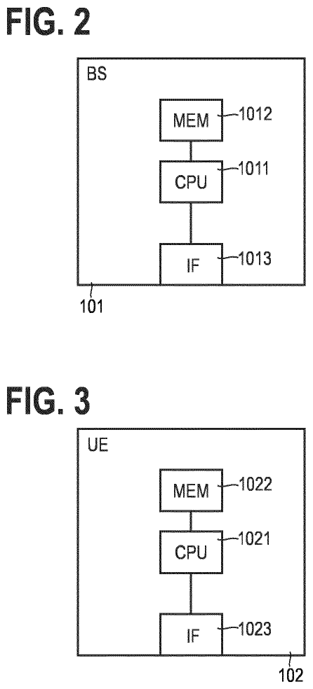

FIG. 2 schematically illustrates the base station 101. The base station 101 includes a processor 1011 and furthermore includes a memory 1012 and a communication interface 1013. The processor 1011 can communicate with the UEs 102 via the communication interface 1013. The communication interface 1013 can include analog electronics to access the carrier 111. The processor 1011 can load program code from the memory 1012 and can execute the program code. Upon executing the program code, the processor 1011 can perform techniques as described herein, e.g.: activating an SSB broadcasting pattern; activating a LP-RS broadcasting pattern; transmitting an SSB in accordance with the SSB broadcasting pattern; transmitting a LP-RS in accordance with the LP-RS broadcasting pattern; obtaining a capability from one or more UEs indicative of whether the one or more UEs are capable to receive the LP-RSs and deciding on whether to activate or not to activate the LP-RS broadcasting pattern; transmitting at least one control signal indicative of the activation of the LP-RS broadcasting pattern.

FIG. 3 schematically illustrates the UE 102. The UE 102 includes a processor 1021 and furthermore includes a memory 1022 and a communication interface 1023. The processor 1021 can communicate with the base station 101 via the communication interface 1023. The communication interface 1023 can include analog electronics to access the carrier 111. The processor 1021 can load program code from the memory 1022 and execute the program code. Upon executing the program code, the processor 1021 can perform techniques as described herein, e.g.: obtaining, from the BS 101, at least one control signal that is indicative of activation of an LP-RS broadcasting pattern; selecting between monitoring of the LP-RS and monitoring of the SSB depending on one or more decision criteria such as signal strength, mobility level, change rate of signal strength and time hysteresis of switching.

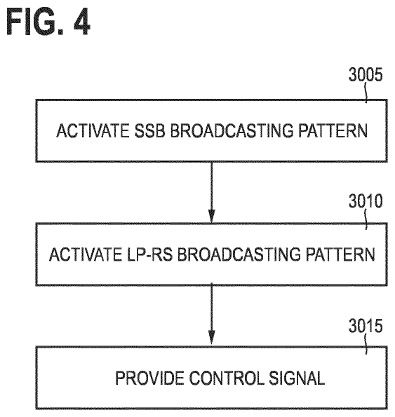

FIG. 4 is a flowchart of a method according to various examples. The method of FIG. 4 can be executed by a base station of a cellular network. For example, the method of FIG. 4 can be executed by the base station 101. In further detail, the method of FIG. 4 could be executed by the processor 1011 upon loading program code from the memory 1012 and upon executing the program code.

At box 3005, a first broadcasting pattern of a reference signal that is mapped to subcarriers of a carrier that is supported by the base station is activated; e.g., an SSB broadcasting pattern is activated.

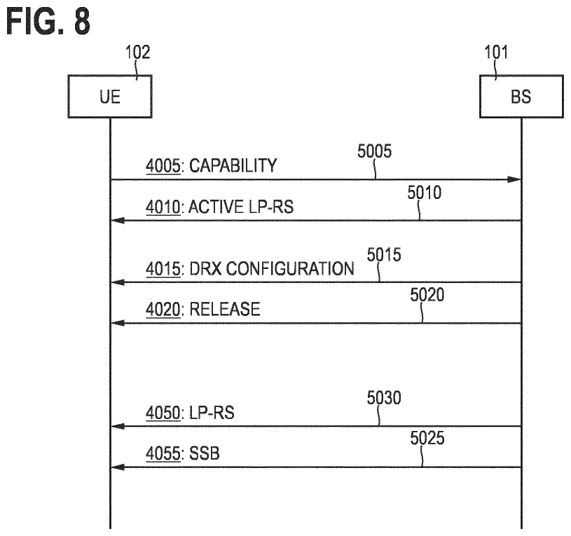

Then, at box 3010, and while the first periodic broadcasting pattern is activated, a second periodic broadcasting pattern of a LP-RS that is designed for noncoherent decoding at UEs that are located in the cell of the base station, is activated. The second periodic broadcasting pattern may be conditionally activated, e.g., if there is at least UE located in the cell of the BS that has the capability for non-coherent decoding of the LP-RS (details will be explained in FIG. 8, 5005)

The first periodic broadcasting pattern and the second periodic broadcasting pattern have a certain predetermined relationship with respect to each other. This means that their time and/or frequency settings can correlate with each other. For instance, different timings are possible, but the time offsets may be fixed or repetitive. For instance, different frequencies can be used that are in a certain relationship with each other.

At box 3015, at least one control signal is provided to one or more UEs in the cell; the at least one control signal is indicative of the activation of the second periodic broadcasting pattern at box 3010.

At least one of the at least one control signal could be provided in a broadcast transmission, e.g., in a system information block (SIB).

For instance, the at least one control signal could also be indicative of the predetermined relationship. For instance, a pointer may be provided which relatively defines a timing and/or frequency and/or time-frequency resources of the second periodic broadcasting pattern relatively with respect to the timing and/or frequency and/or time-frequency resources of the first periodic broadcasting pattern.

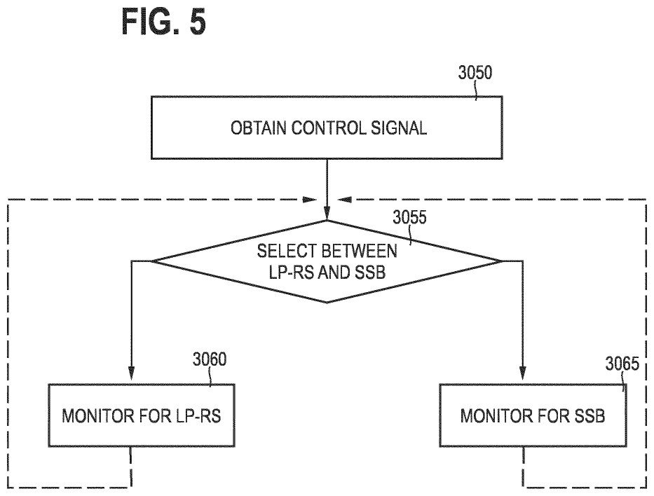

FIG. 5 is a flowchart of a method according to various examples. The method of FIG. 5 can be executed by a UE that can connect to a cellular network (e.g., can attach to or is attached to the cellular network). For example, the method of FIG. 5 could be executed by the UE 102. In further detail, the method of FIG. 5 could be executed by the processor 1021 upon loading and executing program code from the memory 1022.

At box 3050, at least one control signal is obtained from the BS in the cell. The at least one control signal is indicative of the activation of a second periodic broadcasting pattern of a LP-RS, in addition to the activation of a first periodic broadcasting pattern of a reference signal. Box 3050 thus corresponds to box 3015 of the method of FIG. 4.

Then, at box 3055, upon the UE camping on the cell of the BS in an idle mode using discontinuous reception, the UE selects between monitoring of the reference signal and monitoring of the LP-RS. One or more selection criteria can be considered cumulatively and/or serially which may, e.g., include a signal strength of the LP-RS and/or SSB, or a signal strength of the LP-SS and/or SSS that has been previously received, a mobility level of the UE, a change rate of the signal strength of the LP-RS and/or SSB, and/or a temporal hysteresis of switching between monitoring for the LP-RS and the reference signal.

Depending on the outcome of the selection process at box 3055, the method commences either at box 3060 where the UE monitors for the LP-RS to perform a channel measurement based on the LP-RS or LP-SS; or commences at box 3065 where the UE monitors for the reference signal, e.g., SSB, to perform a channel measurement based on the reference signal.

The UE, from time to time, can re-execute the selection at box 3055; i.e., from time to time it may be decided whether to monitor for the SSB or the LP-RS

As a general rule, a rate of monitoring for the LP-RS at multiple iterations of box 3060 may be smaller than a rate for monitoring for the SSB at multiple iterations of box 3065.

The rate for monitoring of the LP-RS may, itself, be dependent on one or more decision criteria, e.g., a signal strength and/or change rate of the signal strength of the LP-RS. For instance, the signal strength of the LP-RS or LP-SS may be compared with a predefined threshold and depending on whether the signal strength is below or above the predefined threshold, a different rate for monitoring of the LP-RS may be used.

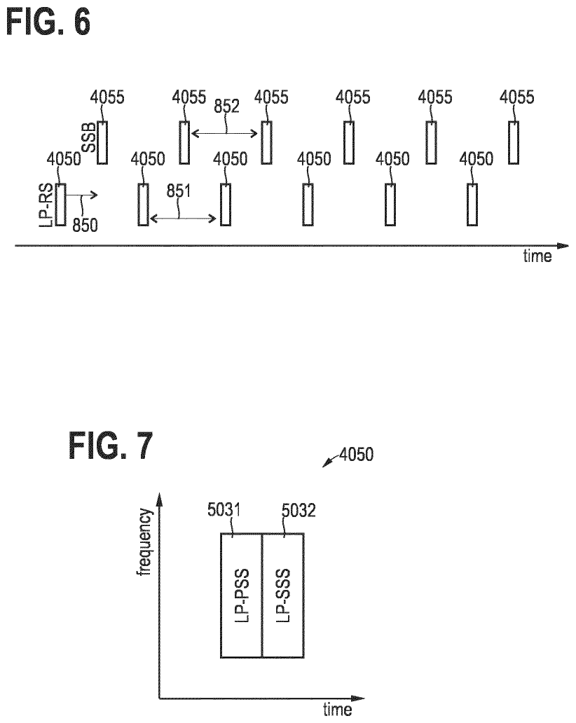

FIG. 6 schematically illustrates a scenario according to which a periodicity 851 with which LP-RS 4050 is re-transmitted in accordance with the LP-RS broadcasting pattern is the same as a periodicity 852 with which the SSB 4055 is retransmitted in accordance with the SSB broadcasting pattern.

A time distance ta 850 between transmitting the LP-RS 4050 and transmitting the next instance of the SSB is illustrated; this time distance 850 is dimensioned such that transmission of the M-Rx into the active state can be accommodated.

FIG. 7 schematically illustrates an example structure of the LP-RS 4050. For instance, the LP-RS 4050 can include two synchronization signals directly adjacent to each other in time domain, i.e., a primary synchronization signal and a secondary synchronization signal. This mimics the structure of the SSB 4055.

However, variations are possible. For instance, it would be possible that the LP-RS only includes a secondary synchronization signal, i.e., without the primary synchronization signal.

In some scenarios, the content of the LP-RS may also be dynamically adjusted. For instance, it one instance, the BS may transmit the LP-RS only including the secondary signal, while at a second instance the BS can transmit the LP-RS that includes, both, the primary synchronization signal, as well as the secondary synchronization signal. For instance, this may depend on a configuration of the BS, e.g., whether mobility is to be considered or not.

FIG. 8 is a signaling diagram of communication between the base station 101 and the UE 102.

At 5005, the UE 102 provides a capability message 4005 to the BS 101, e.g., using an RRC control message.

The capability message 4005 is indicative of the capability of the UE 102 to implement non-coherent decoding of the LP-RS 4050. For instance, the capability message 4005 could be indicative of the UE 102 possessing a low-power receiver.

The UE 102 can provide the capability message 4005 when operating in the connected mode, e.g., when or after establishing the data connection 112.

Then, upon obtaining the indication of the capability of the UE 102 to non-coherently decode LP-RSs 4050, the base station 101 can activate the LP-RS broadcasting pattern and provide a respective control signal 4010 at 5010 (cf. FIG. 4, boxes 3010, 3015).

It would be possible that this control signal also is indicative of a predetermined relationship of the LP-RS broadcasting pattern with respect to an SSB broadcasting pattern. This means that a configuration of the LP-RS broadcasting pattern may be provided relatively with respect to the configuration of the SSB broadcasting pattern. For instance, the time distance 850 could be signaled. It could be indicated whether the same BWP is used for SSB and LP-RS. A frequency distance could be signaled. A transmission power offset between the transmission power of the LP-RS and the transmission power of the SSB could be indicated. The signal strength threshold of LP-Rx for a given cell can also be provided. This signal strength threshold of LP-Rx may not be the same as the legacy signal strength threshold of M-Rx. The LP-Rx signal strength threshold can be provided in a form of the offset from the legacy signal strength threshold based on M-Rx. It would be possible to provide the configuration of the LP-RS broadcasting pattern using a separate signal, distinct from the indication of the activation at 5010; again, the LP-RS configuration could be provided relatively to the SSB configuration.

At 5015, the base station 101 provides, to the UE 102, a discontinuous reception (DRX) configuration message 4015 and, subsequently, at 5020, provides a release message 4020. Accordingly, upon obtaining the release message 4020, the UE 102 transitions to the idle mode. During the idle mode, the UE, monitors either for the LP-RS 4050 at 5030 or for the synchronization signal block 4055 transmitted at 5025, depending on a respective selection at the UE 102 (cf. FIG. 5: box 3055).

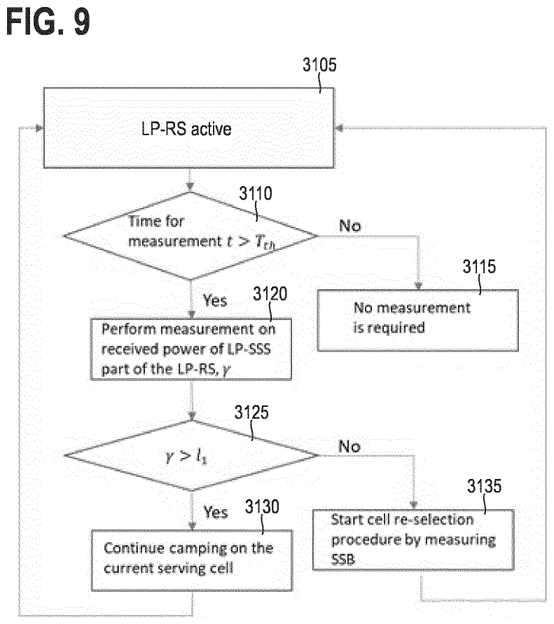

FIG. 9 is a flowchart of a method according to various examples. The method of FIG. 9 illustrates aspects with respect to the selection between monitoring for the SSB 4055 and monitoring for the LP-RS 4050 at the UE 102, cf. FIG. 5: box 3055.

At box 3105, the UE 102, when camping on the cell of the base station 101, i.e., while operating in the idle mode, determines that the LP-RS broadcasting pattern is active.

Then, at box 3110, the UE checks whether it is time for a channel measurement. Here, a timer could be incremented, and the timer value could be compared against a respective predetermined threshold. The timer can be re-set each time a channel measurement is performed.

The predetermined threshold defines the measurement rate of monitoring for LP-RS.

Generally, when monitoring for LP-RSs, a larger timer threshold can be used if compared to when monitoring for SSB for channel measurements, such that the rate of channel measurements is reduced. I.e., a lower rate for monitoring LP-RS if compared for the rate for monitoring SSB may be used.

If a channel measurement is not required, the method aborts at box 3115. Else, the method commences at box 3120.

At box 3120, a received power measurement is performed on the SSS part of the LP-RS, cf. FIG. 7.

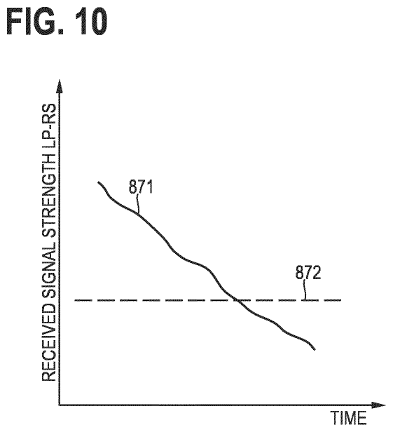

At box 3125, a comparison of the received power against a threshold can be made. This is illustrated in FIG. 10 where the received power 871 as a function of time is plotted with respect to the threshold 872.

If the received power is larger than the threshold, the UE continues camping on the current serving cell, box 3130. The M-Rx needs not to be transitioned into the active state. Else, if the received power from the LP-RS is getting below the threshold 872, the UE may activate the M-Rx by transitioning it into the active state and measures the SSB, box 3135. In some scenarios, one or more criteria may be considered before activating the M-Rx, as discussed above.

Summarizing, a LP-RS intended for a LP-Rx has been disclosed. The LP-RS facilitates channel measurements and specifically serving cell measurements.

The UE may continuously camp on a given cell while only monitoring for the LP-RS; while camping on the given cell, the UE may not be required to monitor SSB.

The LP-RS can be transmitted in association with the SSB. I.e., an SSB broadcasting pattern can be activated while an LP-RS broadcasting pattern is activated.

The LP-RS is transmitted at a certain time offset from the start of the SSB and it may have its own periodicity, e.g., same periodicity as SSB or sparser.

The LP-RS can carry the same content as SSS or PSS+SSS or a different sequence content than SSS/PSS+SSS, but transmitted with a simpler modulation and low complexity coding Both LP-RS and WUS may be transmitted in the same frequency allocation, i.e., BWP.

The UE receives LP-RS and perform serving cell measurement. A time-domain measurement is possible, e.g., based on correlation. For instance, a reference waveform can be correlated with the received waveform.

Strategies have been disclosed how and when to perform measurement on the LP-RS.

The measurement results based on LP-RS can be compared to a threshold to check whether the UE is still camping to the serving cell or not. If the measured level is below certain threshold, the UE can then perform cell-reselection procedure using legacy approach.

A UE supporting LP-RS can declare its capability to the cellular NW.

A BS can provide a LP-RS configuration in SIB or generic RRC message (i.e, receive the configuration when the UE is in connected mode).

Although the invention has been shown and described with respect to certain preferred embodiments, equivalents and modifications will occur to others skilled in the art upon the reading and understanding of the specification. The present invention includes all such equivalents and modifications and is limited only by the scope of the appended claims.

For illustration, above, various scenarios have been disclosed according to which to periodic broadcasting patterns are used for a reference signal designed to be received by a M-Rx and a LP-RS designed to be received by a LP-Rx, respectively, have a predetermined relationship with respect to each other. Similar techniques as disclosed herein may be readily applied to scenarios according to which the two broadcasting patterns do not have any predetermined relationship, but are configured independently.

1. A method of operating a base station associated with a cell of a cellular network, the method comprising:
activating a first periodic broadcasting pattern of a reference signal mapped to subcarriers of a carrier supported by the base station,
while the first periodic broadcasting pattern is activated: activating a second periodic broadcasting pattern of a low-power reference signal designed for a non-coherent decoding at wireless communication devices located in the cell, the first periodic broadcasting pattern having a predetermined relationship with respect to the second periodic broadcasting pattern, and
providing, to the wireless communication devices, at least one control signal indicative of activation of the second periodic broadcasting pattern.

2. The method of claim 1,
wherein the at least one control signal is indicative of the predetermined relationship.

3. The method of claim 1,
wherein the predetermined relationship specifies a relationship between a first periodicity with which the reference signal is broadcasted according to the first periodic broadcasting pattern and a second periodicity with which the low-power reference signal is broadcasted according to the second periodic broadcasting pattern.

4. The method of claim 1,
wherein a first periodicity with which the reference signal is broadcasted according to the first periodic broadcasting pattern is the same or an integer multiple of a second periodicity with which the low-power reference signal is broadcasted according to the second periodic broadcasting pattern.

5. The method of claim 1,
wherein the predetermined relationship specifies a relationship between a first frequency region at which is the reference signal is broadcasted according to the first periodic broadcasting pattern and a second frequency region at which the low-power reference signal is broadcasted according to the second periodic broadcasting pattern.

6. The method of claim 1,
wherein the reference signal and the low-power reference signal are transmitted at the same frequency.

7. The method of claim 1,
wherein the reference signal and the low-power reference signal are transmitted in different bandwidth parts of the carrier.

8. The method of claim 1, further comprising:
responsive to a wake-up event associated with a given wireless communication device of the wireless communication devices: transmitting, to the given wireless communication device, a wake-up signal designed for the non-coherent decoding,
wherein the low-power reference signal and the wake-up signal are transmitted in a joint bandwidth part.

9. The method of claim 1,
wherein the low-power reference signal is cell specific.

10. The method of claim 1, further comprising:
obtaining, from at least one of the wireless communication devices, an indication of a capability of the at least one of the wireless communication devices to implement the non-coherent decoding,
wherein the second periodic broadcasting pattern is selectively activated depending on the indication of the capability.

11. A method of operating a wireless communication device, the method comprising:
obtaining, from a base station associated with a cell of a cellular network, a control signal indicative of activation of a second periodic broadcasting pattern of a low-power reference signal designed for a non-coherent decoding at wireless communication devices located in the cell, and
upon camping on the cell of the cellular network in an idle mode using discontinuous reception: selecting, for channel measurements at the wireless communication device, between monitoring of a reference signal broadcasted using a first periodic broadcasting pattern and monitoring of the low-power reference signal broadcasted using the second periodic broadcasting pattern, the first periodic broadcasting pattern having a predetermined relationship with respect to the second periodic broadcasting pattern.

12. The method of claim 11,
wherein said selecting depends on a signal strength of the low-power reference signal.

13. The method of claim 11,
wherein said selecting depends on a mobility level of the wireless communication device.

14. The method of claim 11,
wherein said selecting depends on a change rate of the signal strength of the low-power reference signal.

15. The method of claim 11,
wherein said selecting depends on a temporal hysteresis of switching between monitoring the reference signal and monitoring the low-power reference signal.

16. The method of claim 11, further comprising:
performing the channel measurements based on the reference signal at a first rate upon selecting said monitoring of the reference signal, and
performing the channel measurements based on the low-power reference signal at a second rate upon selecting said monitoring of the low-power reference signal,
wherein the first rate is larger than the second rate.

17. The method of claim 11, further comprising:
continuously camping on the cell upon selecting said monitoring of the low-power reference signal.

18. The method of claim 11, further comprising:
not monitoring the reference signal while camping on the cell and upon selecting said monitoring of the low-power reference signal.

19. A base station associated with a cell of a cellular network, the base station comprising at least one processor and a memory, the at least one processor, upon loading program code from the memory and executing the program code, being configured to:
activate a first periodic broadcasting pattern of a reference signal mapped to subcarriers of a carrier supported by the base station,
while the first periodic broadcasting pattern is activated: activate a second periodic broadcasting pattern of a low-power reference signal designed for a non-coherent decoding at wireless communication devices located in the cell, the first periodic broadcasting pattern having a predetermined relationship with respect to the second periodic broadcasting pattern, and
provide, to the wireless communication devices, at least one control signal indicative of activation of the second periodic broadcasting pattern.

20. The base station of claim 19, wherein the at least one processor is further configured to execute the method of claim 1 upon loading and executing the program code.

21-22. (canceled)
